(19) United States
(12) Patent Application Publication
(10) Pub. No.: US 2019/0319788 A1
(43) Pub. Date: Oct. 17, 2019

(54) SYSTEM AND METHOD FOR USE IN OPTICAL COMMUNICATION

(71) Applicant: BAR ILAN UNIVERSITY, Ramat Gan (IL)

(72) Inventor: Moti Fridman, Givat Shmuel (IL)

(21) Appl. No.: 16/461,740

(22) PCT Filed: Nov. 28, 2017
(86) PCT No.: PCT/IL2017/051296

§ 371 Date: May 16, 2019

(30) Foreign Application Priority Data
Nov. 30, 2016 (IL) 249317

(51) Int. Cl. H04L 9/08; H04B 10/516; H04B 10/85

(52) U.S. Cl. CPC H04L 9/0861; H04B 10/85; H04B 10/5161

(57) ABSTRACT

A method for use in encryption of optical signal is presented. The method comprising: providing an input optical signal; providing a pump optical signal having a predetermined wavelength and amplitude profile, and interacting said pump optical signal with said input optical signal to thereby generating an encrypted output idler/signal. Further, the invention presents a method of deciphering optical signal comprising: receiving an encrypted input optical signal, providing a decipher pump optical signal having a predetermined wavelength and selected amplitude profile, and interacting said encrypted input optical signal with said decipher pump optical signal providing an output/idler signal; and applying a reverse chirp to said idler signal to provide a deciphered output signal in a form of one or more series of pulses.

### TECHNOLOGICAL FIELD

The invention is in the field of encryption/decryption of optical communication.

### BACKGROUND

Encryption of communication transmission is generally used to prevent unauthorized parties from reading and understanding the content of the transmission. Encryption of data communication becomes important with modern data transmission techniques as well as in view various types of data content.

The existing conventional encryption techniques, being based on software or hardware, typically utilize mathematical representation of the signals and often use various mathematical algorithms for encrypting the transmitted data. Such techniques require analysis of the data to be transmitted, encryption and conversion to optical signals for transmission. Such additional steps may give rise to delays in transmission and latency.

Several methods where presented for optical encryption. Such methods include intensity or phase masks operating in the spatial domain and generally requiring free space optics; and optical quantum encryption capable for operating for short distances and requires electronics detectors and other slow devices.

### GENERAL DESCRIPTION

There is a need in the art for a novel technique for encryption and decryption of optical communication data. The technique of the present invention is substantially all-optical in the meaning that the technique may operate on optical characteristics of the transmission and utilize optical manipulation of light (including UV and IR radiation and additional spectrum ranges with the required variations). Further, the technique of the invention may operate without any need for electronic sub-processes, which are typically slow with respect to bandwidth of optical communication, and is thus generally not limited in communication speed/bitrate, and supports any bitrate supported by the originally designed optical communication system (without encryption).

It should be noted that the technique of the present invention is described herein in correspondence with binary pulse type signal (a series of pulses representing binary code) for simplicity. It is important to note that this is a non-limiting example of pulse on/off coding, while the technique of the invention may be used for encryption and decryption of any optical signal including, but not limited to, Quadrature Amplitude Modulation (QAM) or Wavelength Division Multiplexing (WDM) encoded signals. Further, when utilizing WDM encoded signals, the present technique enables mixing of data bits associated with different wavelength channels in addition, or as alternative, to mixing of data bits associated with different timing. In some signal modulation or encoding technique, the technique of the invention may be efficient for sufficiently high bitrates (e.g. 100 Gb/s and more) and sufficiently wide bandwidths (e.g. lnm) or more.

To this end, the encryption/decryption technique of the invention utilizes generating an output signal being associated with a cross-correlation between the original signal and a selected pump optical signal (acting as encryption key). The input signal may be dispersed/chirped by a predetermined level and the cross-correlation may be generated by interaction of the chirped signal with selected pump optical signal. The technique may result in generating an output encrypted signal that is substantially continuous, i.e. different pulses of the signal overlap to a level that the length of a pulse in the output signal is much larger than temporal delay between pulses as will be explained in more details further below. Additionally, decryption of such encrypted communication signal may be performed by causing suitable interaction of an input encrypted signal stream with a suitable pump signal, and applying reverse chirp on the so-generated signal to reconstruct the original signal.

More specifically, the encryption technique of the invention comprises: providing an input optical signal; providing a pump optical signal with selected wavelength range and amplitude profile, and interacting said pump optical signal with said input optical signal to thereby generate an idler signal. The idler signal is effectively an encrypted representation of the input signal and may be transmitted, preventing unauthorized partied from recognizing the content thereof. The method may also comprise applying a predetermined chirp onto said input optical signal thereby varying temporal relation between frequency components of said input optical signal to provide a chirped input optical signal, and further interacting said chirped input optical signal with said pump optical signal.

The pump optical signal is generally configured with selected or predetermined wavelength range and amplitude profile providing an encryption key. More specifically, data about the pump optical signal may be used for determining a decryption key for deciphering the encrypted signal to identify content thereof.

To this end, the decryption technique of the invention comprises: receiving an encrypted input optical signal; providing a pump optical signal having a selected wavelength range and amplitude profile, and interacting said encrypted input optical signal with the pump optical signal to provide an idler signal, generally associated with cross correlation between the input and pump signals; and applying a reverse chirp to said idler signal to provide a deciphered signal. The pump optical signal is selected to have substantially similar wavelength range, and to have an amplitude profile selected in accordance with amplitude profile of the encryption pump optical signal, such that the amplitude profile of the pump optical signals acts as encryption/decryption key. Generally the encryption and decryption pump optical signals have a predetermined relation between them. In some embodiments, the relation between the encryption and decryption pump optical signals is associated with a correlation between amplitude profiles thereof, for example, a correlation between the amplitude profiles of the encryption and decryption pump optical signals may form a delta function.

It should be noted that the encryption and decryption according to the present invention may generally be performed as an all-optical technique and thus eliminate, or at least significantly reduce any latencies that may be caused by computational processes and conversion of the signal from optical to electronic and vice versa. Additionally, as indicated above, the technique is generally not limited to any bandwidth and/or bitrate of data transmission and can support any bitrate that may be transmitted optically.

Also, the technique of the present invention may be fully embedded in optical fiber system. More specifically, the optical signals, along the entire technique, are propagating in optical fibers and may be transmitted via optical fibers to a destination, where it may be deciphered while propagating in optical fibers, and only then detected and converted to electronic signals. Alternatively, the optical signals may undergo free-space propagation in one or more of the stages of encryption, decryption and transmission thereof.

Thus, according to one broad aspect, the present invention provides a method for encryption of optical signal, the method comprising:
providing an input optical signal;
providing a pump optical signal having a predetermined wavelength and amplitude profile;
and interacting said pump optical signal with said input optical signal to thereby generating an encrypted output idler/signal.

According to some embodiments, the method may further comprise applying a predetermined chirp to the input optical signal to thereby vary temporal relation between frequency components of said input optical signal providing a chirped input optical signal interacting said chirped input optical signal with said pump optical signal.

The input optical signal may be in the form of at least one series of pulses having predetermined repetition rate and predetermined central wavelength. Additionally or alternatively, the input signal may be encoded by Quadrature Amplitude Modulation (QAM) or Wavelength Division Multiplexing (WDM) or any other encoding technique used for optical communication. In such configurations, the input optical signal may be in the form of a plurality of series of pulses representing corresponding wavelength channels. Accordingly temporal mixing of pulses may be used together with mixing of wavelength channels. Generally, central wavelength of the encrypted output idler/signal may be determined in accordance with central wavelength of the input signal and said predetermined wavelength of the pump optical signal.

In some embodiments, interacting said pump optical signal with said input optical signal may comprise generating an idler signal corresponding to a cross-correlation, or being a result on nonlinear interaction, between said input optical signal and said pump optical signal.

For example, interacting the pump optical signal with the input optical signal may comprise directing the input optical signals and the pump optical signals to pass through a non-linear medium to thereby generate nonlinear interaction. Such nonlinear interaction may comprise at least one of the following: 3 wave-mixing, 4 wave-mixing, Raman interaction, Brillouin interaction, Kerr effect or any other nonlinear interaction between two or more input signals generating one or more idler signals.

According to some embodiments of the invention, the encrypted output idler/optical signal is substantially continuous optical signal. More specifically, it is generally impossible to define pulses in the output (encrypted) signal.

According to some embodiments, providing a pump optical signal may further comprise applying a predetermined chirp to said pump optical signal. Generally, the pump optical signal may be provided in the form of a series of pulses (comb like), and after applying dispersion to the pump signal, it may be of almost CW form, i.e. the pulses of the pump signal may effectively overlap between them. The predetermined chirp applied to the pump signal may preferably be of higher level with respect to level of chirp applied to the input optical signal. In some embodiments, the pump signal may be chirped by applying dispersion that is twice stronger than that of the input signal.

Generally, according to the present invention, the wavelength and amplitude profile of the pump optical signals is selected as an encryption key. More specifically, if the pump optical signal is modulated before applying dispersion thereto, the modulation is considered as frequency modulation, which results in amplitude modulation after dispersion and vice versa.

According to one other broad aspect, the present invention provides a method for deciphering optical signal, the method comprising:
receiving an encrypted input optical signal;
providing a decipher pump optical signal having a predetermined wavelength and selected amplitude profile, and interacting said encrypted input optical signal with said decipher pump optical signal providing an output/idler signal; and
applying a reverse chirp to said idler signal to provide a deciphered output signal in a form of one or more series of pulses.

According to some embodiment, interaction said encrypted input optical signal with said decipher pump optical signal may comprise generating a cross-correlation idler, being indicative of cross-correlation between the input optical signal with said decipher pump optical signal.

The selected amplitude profile of the pump optical signals may be selected in accordance with amplitude profile of encryption pump optical signals thereby providing an encryption/decryption key. More specifically, the selected amplitude profile of the pump optical signals is selected such as correlation between said amplitude profile and amplitude profile of the encryption pump optical signals provide a delta function form.

According to yet another broad aspect, the present invention provides an encryption system comprising:
input and output ports configured respectively for receiving an input optical signals and transmitting output optical signals;
signal dispersion unit configured for applying certain level of group velocity dispersion on said input signals thereby generating a chirped input signal;
a pump signal source configured for providing pump optical signal having a predetermined wavelength and amplitude profile; and
a cross-correlation module configured interacting said chirped input signal with said pump optical signal to thereby generate an encrypted output optical signal.

As indicated above, the input optical signal may comprise one or more series of optical pulses, said encrypted output signals is substantially continuous optical signal. Additionally or alternatively, the input signal may be encoded by Quadrature Amplitude Modulation (QAM) or Wavelength Division Multiplexing (WDM) or any other encoding technique used for optical communication.

The encryption system may be configured as all optical encryption of input optical signals.

According to some embodiments, the pump signal source may further comprise a pump modulation unit configured and operable for selectively modulating spectrum or amplitude of said pump optical signal. The pump signal source may further comprise a pump dispersion unit configured for applying predetermined dispersion to the pump optical signal.

The pump amplitude modulation unit may be configured and operable for manipulating spectrum/amplitude of said pump optical signals in accordance with data about an encryption key.

According to some embodiments, the nonlinear interaction between said input signal and said pump optical signals is a 4 wave-mixing 3 wave-mixing, Raman interaction, Brillouin interaction, Kerr effect or any other nonlinear interaction between two or more input signals generating one or more idler signals.

The pump signal source may be configured for receiving input optical pump illumination via a pump input port. Alternatively or additionally, the pump signal source may comprise a pump source unit configured for generating coherent electromagnetic radiation of said predetermined wavelength of the pump signal.

According to yet another broad aspect, the present invention provides an optical decryption system comprising:
input and output ports configured respectively for receiving an input optical signals and transmitting output optical signals;
a pump signal source configured for providing pump optical signal having a predetermined wavelength and amplitude profile;
a cross-correlation module configured interacting said input signal with said pump optical signal to thereby generate an encrypted output optical signal; and
signal dispersion unit configured for applying certain level of group velocity dispersion on said input signals.

According to some embodiments, the cross-correlation module comprises nonlinear birefringent element, said chirped input signal and said pump optical signal being transmitted therethrough with orthogonal polarities, to thereby provide cross-correlation between them.

According to some embodiments the wavelength and amplitude profile of the decryption pump optical signal is selected in accordance with wavelength and amplitude profile of an encryption pump optical signal.

The decryption system may be configured as all optical decryption of input optical signals.

According to some embodiments, the pump signal source may further comprise a pump modulation unit configured and operable for selectively modulating spectrum or amplitude of said pump optical signal. Additionally, the pump signal source may further comprise a pump dispersion unit.

The pump amplitude modulation unit may be configured an operable for manipulating spectrum/amplitude of said pump optical signals in accordance with data about an encryption key.

According to some embodiments, the nonlinear interaction between the input signal and the pump optical signals is selected from any of 4 wave-mixing 3 wave-mixing, Raman interaction, Brillouin interaction, Kerr effect or any other nonlinear interaction between two or more input signals generating one or more idler signals.

According to some embodiments, the pump signal source may be configured for receiving input optical pump illumination via a pump input port. Additionally or alternatively, the pump signal source may comprise a pump source unit configured for generating coherent electromagnetic radiation of said predetermined wavelength of the pump signal.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 schematically illustrated main action in transmission and reception of encrypted optical signals;

FIG. 2 illustrates basic operational process for encryption and decryption of optical signals according to some embodiments of the invention;

FIG. 3 shows a schematic configuration of an encryption system according to some embodiments of the invention;

FIG. 4 shows a schematic configuration of a description system according to some embodiments of the invention; and

FIGS. 5A to 5E show some signal profiles describing the technique of the invention, the profiles include optical signal profiles before (FIGS. 5A and 5B) and during (FIG. 5C) encryption, intermediate pump signal profile (FIG. 5D) and output encrypted signal profile (FIG. 5E).

### DETAILED DESCRIPTION OF EMBODIMENTS

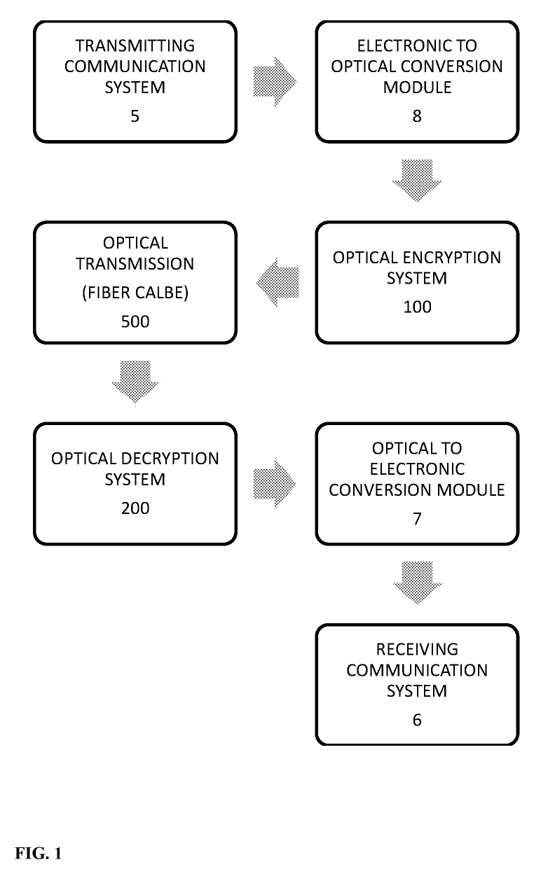

As indicated above, the technique of the present invention provides for encryption of communication data. Reference is made to FIG. 1 showing a communication process in which the data is encrypted prior to be transmitted to its destination, and decrypted again after being received at the destination. Differently than the conventional encryption techniques, the technique illustrated in FIG. 1 utilizes encryption and decryption of the optical signals. Moreover, the optical signals are processed utilizing characteristics and parameters that are relatively unique to such signals. Such encryption technique does not require any signal processing and may thus support any beat rate and bandwidth capable of being transmitted by the corresponding optical communication network.

As shown, a transmitting communication system 5, generally a computer system or any other electronic system, may generate data to be transmitted. The electronic data is converted to be carried by optical signals by an electronic to optical (E2O) module 8 generating optical signal in the form of one or more series of pulses, where each series is characterized by a carrying central wavelength. The optical signal is transmitted into an optical encryption system 100, configured according to some embodiments of the present invention, for encryption. The optical encryption system 100 is configured for modulating and varying the optical signal such that contents thereof are not available to a recipient without the use of a suitable decryption key. Moreover, according to some embodiments of the invention, the resulting encrypted optical signal may be substantially continuous wave signal (i.e. it is substantially impossible to define pulses of the signal), thus it may appear to a recipient as if it does not carry any information.

The encryption technique according to the present invention is based on mixing neighboring bits of an input signal, using weights for the bits, selected according to a function acting as an encryption key. The mixing is done by applying dispersion, thus varying temporal relations between frequency components of the signal bits, and causing interaction between the so-modulated signal and a pump signal carrying the key function. Such interaction may be four-wave mixing interaction or generally any nonlinear interaction as will be described in more details further below.

The resulting encrypted signal may be transited 500 to a desired recipient via any technique and medium suitable for carrying optical communication signals. For example, the optical signals may be transmitted via optic fibers or to be allowed to propagate in free space. Alternative transmission techniques may also be used.

At the receiving side, the input optical signal is directed to an optical decryption system 200 configured according to some embodiments of the invention. The optical decryption system 200 utilizes a selected suitable decryption key for deciphering the signal content from the received encrypted signal. Upon deciphering the signal, it may be transmitted to an optical to electronic conversion module 7 (02E) and further to a receiving communication system 6 for processing. Generally, the decryption technique is based on a second key function, selected as being orthogonal to the encryption key function. As will be described in more details further below, the decryption is done by optical cross-correlation of the encrypted input signal with the decryption key function.

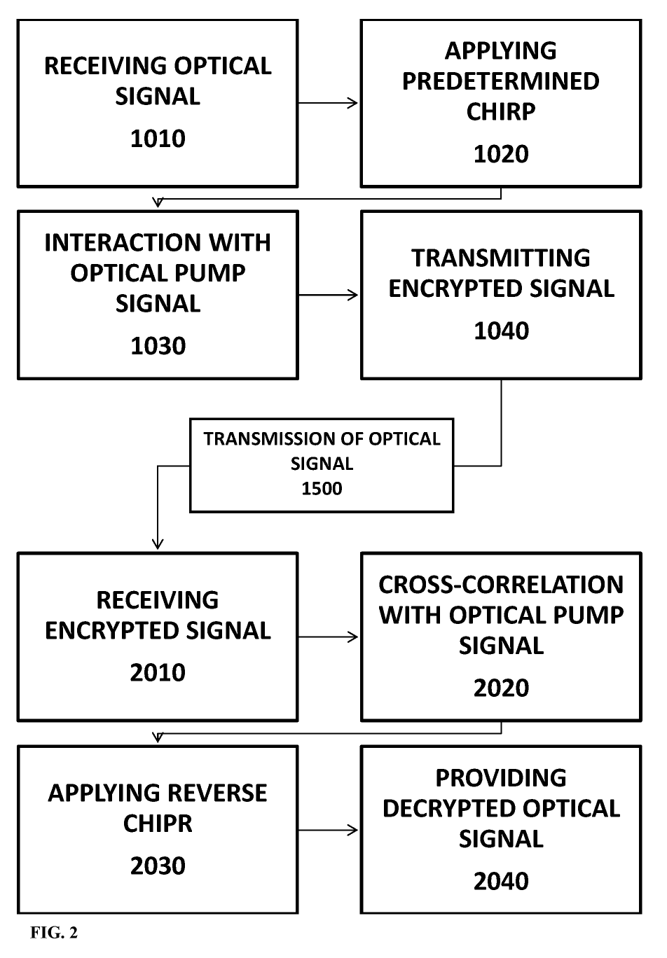

The encryption and decryption according to the technique of the invention may typically be all-optical processes including selected modulations of the optical signals. Reference is made to FIG. 2 schematically illustrating encryption and decryption of optical signals according to the present technique. For simplicity, FIG. 2 relates to encryption process, transmission of the encrypted signals and to the decryption process. It should be noted that the encryption and decryption processes are separate techniques having certain correspondence between them. More specifically, to decipher data encrypted according to the technique of the invention, a corresponding decryption technique with suitable decryption key should be used. However, the encryption and decryption are typically being performed at different locations by different sides (corresponding to transmitting unit and receiving unit of a communication path).

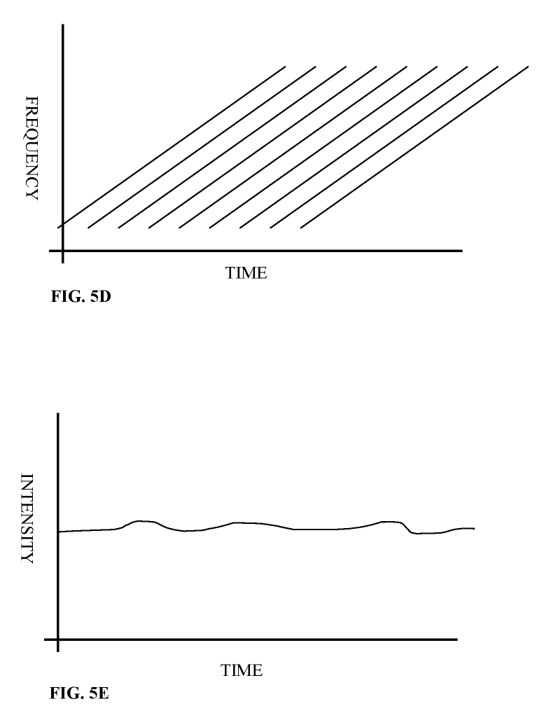

As shown in FIG. 2, an optical signal, typically carrying one or more series of optical pulses as exemplified in FIGS. 5A and 5B, is received 1010 for encryption (e.g. through an input port). A predetermine chirp level is applied 1020 to the input signal, to thereby generate a chirped signal is exemplified in FIG. 5C. In this connection the term chirp relates generally to a signal having frequency that varies with time, preferably monotonically. For example, the chirped signal may have substantially linear frequency-time variation of the chirped signal is shown in FIG. 5C.

In order to fully encrypt the signal content, the chirped signal is interacted with a predetermined optical pump signal 1030. The interaction between the two signals may generally be a nonlinear interaction, such as four wave mixing, three wave mixing, difference frequency generation or other nonlinear interactions taking place between two or more optical radiation components. The nonlinear interaction takes place by transmitting both chirped signal and optical pump signal through a medium having suitable substantial nonlinear coefficient. The time-frequency representation of FIGS. 5C and 5D illustrates the instantaneous frequencies of the signal as function of time. This representation of the signal and pump characteristics provides understanding of a resulting idler signal generated by interaction between the chirped signal of FIG. 5B and the pump signal, exemplified in FIG. 5C.

The pump optical signal is configured with selected frequency range and amplitude profile to provide desired encryption. More specifically, the frequency range of the pump is selected in accordance with frequency range of the input signal to be encrypted and frequency range supported by the transmission route (e.g. optical fibers). Additionally, the optical pump signal may be amplitude or frequency modulated in accordance with a selected function that typically acts as encryption key as will be described in more details further below. Additionally, as shown in the example of FIG. 5C, the optical pump signal may be chirped to map correlation between pump amplitude and frequency temporal variation.

An idler signal, exemplified in FIG. 5E, is generated as a result of the interaction between the chirped input signal and the optical pump signal. The idler signal actually carries the encrypted data from the original input signal, but has characteristics of almost continuous wave signal without defined pulses, and therefore can be safely transmitted 1040 to a selected recipient. As indicated above, the encrypted signal may be transmitted through any system 1500 used for optical communication. For example, the optical signals may be transmitted through optical fiber or fiber bundles, propagating in free space/through air or any other technique.

The recipient side of the communication receives optical signal, and may operate to decipher the content of the signal using knowledge of a corresponding encryption key. To this end, after receiving an optical signal 2010, the recipient system is operated for cores-correlating 2020 the input signal with a corresponding optical pump signal (decryption pump optical signal). Generally, cross-correlation gives a measure of similarity between two input signals (in this case the encrypted input and the decryption pump signals). The cross correlation signal/idler may be formed by transmitting both input signal and decryption pump optical signal through corresponding nonlinear medium having predetermined birefringence property, such that the input and pump signals have orthogonal polarizations. Alternatively or additionally, the decryption pump optical signal may be duplicated to several copies, where each copy is interacted with the input signal with selected temporal shifts. According to some other technique the cross-correlation may be generated in free space propagation of optical signals.

Generally, for different temporal shifts, the cross-correlation between the input encrypted signal and an optical pump signal may be generated by nonlinear interaction between the signals in a similar manner to that of the encryption technique. In a specific example of four wave mixing interaction (both for encryption and decryption), the encrypted input signal and the pump signal, having frequency and/or amplitude modulated in accordance to decryption key function, are transmitted through a selected nonlinear medium for generate and idler signal by four wave mixing.

To reconstruct the encrypted data, the technique further includes suitably chirping 2030 of the idler signal, generated by cross-correlation of the input encrypted signal a decryption optical pump signal. Chirping of the idler signal for decrypting the content is generally of opposite sign (reverse chirp) to that of the encryption technique. This provides 2040 reconstructed signal corresponding to the original, data-containing, signal.

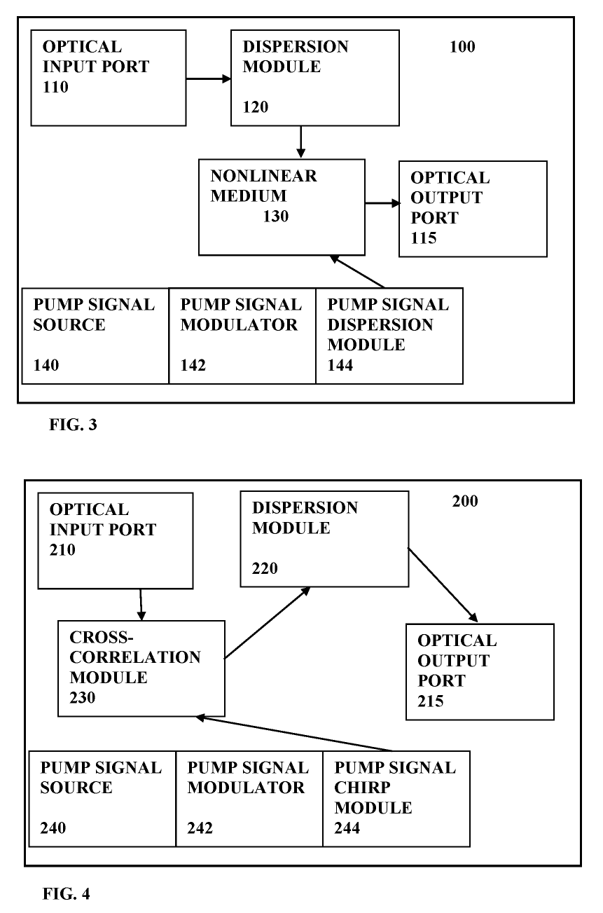

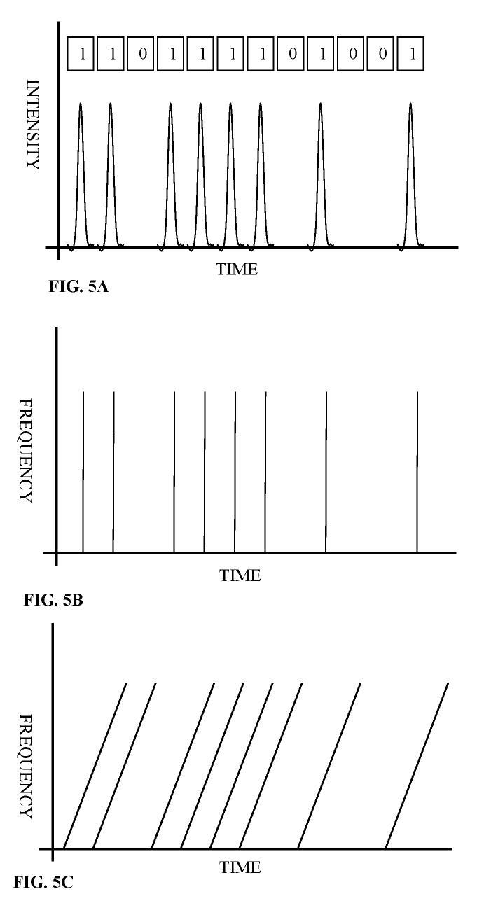

As indicated above, the technique exemplified in FIG. 2, according to the invention, may be configured as all-optical encryption and decryption techniques. Alternatively, optical two electronic conversions may be used for cross-correlation of the encrypted signal with the decryption optical pump signal. It should however be noted that while all-optical manipulation of the signal may be performed almost at any bitrate, the conversion of optical signals to electronic signals may cause certain latency and bitrate limitations in accordance with the electronic tools used. FIGS. 3 and 4 illustrate in a way of block diagrams systems for optical encryption and decryption respectively.

FIG. 3 exemplifies an encryption system 100 according to some embodiments of the invention. The system includes an input port 110 for receiving input optical signal to be encrypted; a dispersion module 120 configured for applying certain selected group velocity dispersion on the signal; a pump signal source 140, typically also including a pump signal modulator 142; a nonlinear medium 130 for promoting interaction between the dispersed signal and the optical pump signal and an optical output port 115.

The dispersion module 120 may be a long optical fiber having certain group velocity dispersion (GVD), or any medium having appropriate with suitable GVD. In some embodiments, the dispersion module may be configured to cause polarization related dispersion to the signal using material having certain birefringence effect. As indicated above, the dispersion module receives input signal including one or more series of pulses as exemplified in FIGS. 5A and 5B, and by applying dispersion between different frequency components of the pulses, generates a chirped signal as exemplified in FIG. 5C. As indicated above, the dispersion module may be formed by any material having appropriate dispersion properties such as long optical fiber. In the case of polarization dispersion, such birefringence effect may be induced by applying stress on optical fiber, e.g. introduced during the process of pulling the fiber or using single mode fiber rolled to small diameter and thus also enabling tuning of the stress level.

The dispersion module 120 further transmits the chirped signal to for interaction with a pump optical signal in a nonlinear medium 130 for generating an idler signal. The idler signal relates to correlation between the chirped input signal and a selected optical pump signal in accordance with the type of nonlinear interaction between them. As indicated above, the nonlinear medium may promote various types of nonlinear interactions such as four wave mixing, three wave mixing, difference frequency generation as well as Raman interaction, Brillouin interaction and/or Kerr effect. Generally the nonlinear medium may promote any nonlinear interaction in which two or more input optical signals interact and generate one or more output idler signals.

An example of nonlinear interaction that may be advantageously used in the nonlinear medium 130 according to the technique of the invention is four wave mixing (FWM). In four-wave mixing an output idler beam Eᵢ is created by the nonlinear interaction between a strong pump beam Eₚ and a signal beam Eₛ according to

Eᵢ(t)=χ⁽³⁾Eₚ(t)²Eₛ(t)* (equation 1)

This provide an idler resulting optical wave/signal having frequency ωᵢ given by

ωᵢ=2ωₚ−ωₛ, (equation 2)

where ωₚ is the frequency of the pump wave and ωₛ is the frequency of the signal wave. This, a difference between the idler's instantaneous frequency and the pump instantaneous frequency is proportional and opposite with respect to the difference between the signal instantaneous frequency and the pump instantaneous frequency at corresponding times.

The Four-wave mixing between pump wave and signal wave having amplitudes Aₚ(t) and Aₛ(t) respectively, creates an idler wave with amplitude Aᵢ(t), given by

Aᵢ(t)∝Aₛ(t)*Aₚ²(t). (equation 3)

and the intensity of the idler, e.g. measured by a slow detector, provide a measure to the correlation.

According to some embodiments of the invention, the cross-correlation module may include a long optical fiber having certain birefringency property and providing nonlinear characteristics. The input signal and the optical pump signal may be coupled into the fiber with orthogonal polarizations, and thus propagate at different group velocities. Thus the pump and the signal sweeps over each other and generate nonlinear interactions therealong.

According to another example, the cross-correlation may be formed by utilizing chirped pump as well as chirped input signal. This is exemplified in FIG. 3 showing the pump optical signal source 140 including a pump signal modulator 142 and a pump signal chirp module 144. Chirping of the pump signal provides time-to-frequency mapping such that the frequency of the idler is generated as a function of the temporal delay between the signal and the pump. Generally chirping the pump signal provides a mapping between amplitude and frequency/wavelength modulations. Thus, for different temporal separations the generated idler has different frequencies.

This can be exemplified by expressing the frequency of the chirped signal wave as (assuming linear chirp):

ωₛ(t)=ωₛ₀+α(t+Δt), (equation 4)

where ωₛ₀ is the central frequency, and a is the slope of the chirp. Since the frequency of the resulting idler is

ωᵢ=2ωₚ−ωₛ, (equation 5)

if the slope of the chirped pump is selected to be α/2 such that,

$${ω}_{p} ( t ) = {ω}_{p 0} + \frac{α}{2} t , \qquad ( equation 6 )$$

where ωₚ₀ is the central frequency, the frequency of the generated idler is given by,

ωᵢ=2ωₚ₀−αΔt. (equation 7)

As seen from equations 6 to 9, bandwidth of the idler signal, generated by nonlinear cross-correlation between chirped input signal and chirped pump signal according to this example is substantially smaller than the bandwidth of the signal or the pump. Moreover, the frequency of the idler signal is almost constant in time and depends of the correlation between the input and pump signals.

For temporal separation Δt between the signal and the idler waves, equation 4 provides

Aᵢ(Δt)∝∫Aₛ(τ+Δt)Aₚ(τ)²dτ. (equation 8)

Utilizing equation 9 in combination with equation 8 and 6 gives

$${A}_{i} ( \frac{{ω}_{i} - {ω}_{i 0}}{α} ) ∝ \int {A}_{s} ( τ + Δ t ) {{A}_{p} ( τ )}^{2} d τ , \qquad ( equation 9 )$$

where ωᵢ₀ is the central frequency and Aᵢ(ωᵢ) is the spectrum of the idler wave/signal. Thus, the spectrum of the resulting idler wave is proportional to the cross-correlation between the signal wave and the square of the pump wave. Further, the idler wave may be transmitted to a selected recipient through any communication/transmission channel and can only be read by inversion of the cross correlation with an appropriate pump signal.

More specifically, assuming the original input signal, to be encrypted, is in the form of a series of pulses providing Sₙ={1, 1, 0, 1, 0, . . . } it may be represented as an optical signal wave as

Eₛ(t)=Σₙ₌₁^{N}δ(t−n·Δt)Sₙ, (equation 10)

where, Δt is the time separation between adjacent bits, and δ may be estimated as the Kronecker delta function, or narrow Gaussian, representing the pulses as exemplified in FIG. 5A. It is clear that to provide short pulses, all the corresponding frequencies of the signal should have suitable phase and thus arrive at the same time, as exemplified in FIG. 5B.

After mixing a chirped signal (as exemplified in FIG. 5C) with a chirped pump signal having selected modulation key function (exemplified in FIG. 5D) the intensity distribution of the pump wave, acting as encryption key, is multiplied with each bit of the signal resulting in the idler wave:

Eᵢ(t)=Σₙ₌₁^{N}Eₚ(t−n·Δt)Sₙ, (equation 11)

where Eₚ(t) is the intensity distribution of the pump wave. The length, or period of modulation, of the pump wave may determine the strength of the encryption. Generally for longer pump signal (longer modulation period) more bits intermix with each other.

Thus, the cross correlation module 130 generates an idler signal, acting as encrypted version of the original signal. As indicated above, cross correlation module 130 may be a highly nonlinear medium promoting such nonlinear interaction between the input (chirped) signal and the optical pump signal. As also indicated, the cross correlation module 130 may include a birefringence element enabling polarization related cross-correlation between the signals.

When the idler, encrypted signal is generated, it may be transmitted through any optical transmission system from the optical output port 115.

At the recipient end of the transmission system, a recipient must decrypt the input signal using an appropriate decryption key in order to read the content of the signal. FIG. 4 illustrates a decryption system 200 according to some embodiments of the invention. The decryption system 200 includes an input port 210 for receiving input optical signals; a pump signal source 240 also including a pump signal modulator 242 configured to provide an appropriately modulated pump optical signal that can act as decryption key; a cross-correlation module 230 for generating a decryption idler signal by determining cross correlation between the input encrypted signal and the decryption pump. Further the decryption system 200 generally includes is a dispersion module 220 configured for applying revers chirp on the idler signal to restore a signal containing data that can be read, and an optical output port 215 configured to enabling connection of any optical communication device that may receive and read the input signal after decryption.

The optical input port 210 may be directly connected to an optical transmission system to receive an input optical signal \tilde{E}ₛ (encrypted). Being the input Eᵢ(t) of the decryption system 200:

\tilde{E}ₛ(t)=Eᵢ(t), (equation 12)

The input signal is transmitted to the cross-correlation module 230 for generating cross-correlation with a decryption optical pump signal \tilde{E}ₚ. To provide decryption of the input signal, the pump signal, provided by the pump signal source 240 is modulated by the pump signal modulator 242 to in accordance with the pump optical signal used for encryption.

As mentioned above, cross-correlation provides a measure for similarity between two input signals. For two input signals ƒ(t) and g(t) the cross correlation h(τ) is given by

h(τ)=∫_{-∞}^{∞}ƒ(t)g(t−τ)dt. (equation 13)

A peak in the correlation function h(τ) for one or more specific values τ₀ represents a high similarity between the two functions when one is shifted by τ₀ compare to the other. Generally, cross-correlation may obtained by sweeping one function compared to the other and to calculate the correlation for every value of τ. Additionally or alternatively, the cross-correlation may be generated utilizing convolution theorem. This technique may utilize the knowledge that a multiplication in Fourier space is equivalent to convolution in real space. More specifically, the decryption optical pump signal \tilde{E}ₚ(t) is preferably configured with amplitude or frequency modulation according to a modulation function that is orthogonal to the modulation of the encryption pump optical signal Eₚ(t), such that

∫Eₚ(t)\tilde{E}ₚ(t+Δt)dt=δ(Δt). (equation 13)

For example, the encryption and decryption keys may be similar random functions, sine or cosine functions with corresponding frequencies or any other two orthogonal functions.

Thus, the pump signal source 240 may generally include pump signal modulator 242 and pump signal chirp module 244 for appropriately shaping the optical pump signal for decryption in accordance with data about the encryption key. The pump source system 240 is generally configured for providing and modulating the pump signal in accordance with pre-provided data about the encryption key. Both the decryption pump signal and the encrypted input signal [symbol] are transmitted to the cross-correlation module 230, which may be configured substantially similar to the cross-correlation module 130 of the encryption system, i.e. nonlinear medium and possibly long birefringence optical fiber, for sweeping the pump over the encrypted signal \tilde{E}ₛ and generating corresponding idler signal.

The so-generated idler signal is transmitted to the dispersion module 220, which is configured to apply group velocity dispersion and chirp the to an opposite level of the chirp at the encryption system 100. The resulting optical signal is a reconstructed version of the original signal including one or more series of pulses indicative of data to be transmitted and is directed to any communication device through the optical output port 215.

Generally the cross-correlation between the input signal [symbol] and the decryption pump signal [symbol] provides a decryption idler signal:

\tilde{E}ᵢ(\tilde{t})=∫\tilde{E}ₛ(t)\tilde{E}ₚ(t+\tilde{t})dt, (equation 14)

Utilizing equations 13 and 14 above provides

\tilde{E}ᵢ(\tilde{t})=∫Σₙ₌₁^{N}Eₚ(t−n·Δt)Sₙ\tilde{E}ₚ(t+\tilde{t})dt, (equation 15)

Replacing the order of the summation and the integral, and substituting equation 14 relating to key function of the pump signal provides:

\tilde{E}ᵢ(\tilde{t})=Σₙ₌₁^{N}δ(n·Δt−\tilde{t})Sₙ, (equation 16)

which provides reconstruction of the encrypted data.

FIGS. 5A to 5E illustrate wave function of the input signal to be encrypted and the encryption technique as described above. FIG. 5A exemplifies a signal containing a series of pulses in intensity vs. time graph; FIG. 5B shows similar signal in frequency vs. time graph; FIG. 5C shows chirped input signal in frequency vs. time graph; FIG. 5D shows a chirped pump signal, configured as a series of pulses in frequency vs. time graph; and FIG. 5E exemplifies a resulting encrypted signal in frequency vs. time graph.

Thus, the technique of the present invention provides an all-optical encryption and decryption of communication data. As indicated above, the technique is only limited by bandwidth and bitrate of a transmission system and that of any communication systems generating and receiving the communication data, and thus may operate in very high bitrates without any latency, which may result from data processing.

1. A method for encryption of optical signal, the method comprising:
providing an input optical signal;
providing a pump optical signal having a predetermined wavelength and amplitude profile; and
interacting said pump optical signal with said input optical signal for generating an idler signal being an encrypted output signal.

2. The method of claim 1, further comprising applying a predetermined chirp onto said input optical signal to thereby vary temporal relation between frequency components of said input optical signal providing a chirped input optical signal interacting said chirped input optical signal with said pump optical signal.

3. The method of claim 2, wherein said providing a pump optical signal further comprises applying a predetermined chirp to said pump optical signal.

4. The method of claim 1, wherein said input optical signal being in the form of at least one series of pulses having predetermined repetition rate and predetermined central wavelength, central wavelength of said encrypted output idler/signal is determined in accordance with central wavelength of the input signal and said predetermined wavelength of the pump optical signal.

5. The method of claim 1, wherein said interacting said pump optical signal with said input optical signal comprises generating an idler signal corresponding to a cross-correlation between said input optical signal and said pump optical signal.

6. The method of claim 1, wherein said interacting said pump optical signal with said input optical signal comprises directing said input optical signals and said pump optical signals to pass through a non-linear medium to thereby generate nonlinear interaction.

7. The method of claim 6, wherein said nonlinear interaction comprises at least one of the following: 3 wave-mixing, 4 wave-mixing, Raman interaction, Brillouin interaction, or Kerr effect.

8. The method of claim 1, wherein said encrypted output idler/optical signal is substantially continuous optical signal.

9. (canceled)

10. The method of claim 1, wherein said wavelength and amplitude profile of the pump optical signals is selected as an encryption key.

11. A method of deciphering optical signal, the method comprising:
receiving an encrypted input optical signal;
providing a decipher pump optical signal having a predetermined wavelength and selected amplitude profile;
interacting said encrypted input optical signal with said decipher pump optical signal providing an output/idler signal; and
applying a reverse chirp to said idler signal to provide a deciphered output signal in a form of one or more series of pulses.

12. The method of claim 11, wherein said interaction said encrypted input optical signal with said decipher pump optical signal comprises generating a cross-correlation idler, being indicative of cross-correlation between the input optical signal with said decipher pump optical signal.

13. The method of claim 11, wherein said selected amplitude profile of the pump optical signals is selected in accordance with amplitude profile of encryption pump optical signals thereby providing an encryption/decryption key.

14. The method of claim 13, wherein said selected amplitude profile of the pump optical signals is selected such as correlation between said amplitude profile and amplitude profile of the encryption pump optical signals provide a delta function form.

15. An encryption system, comprising:
input and output ports configured respectively for receiving an input optical signals and transmitting output optical signals;
signal dispersion unit configured for applying certain level of group velocity dispersion on said input signals thereby generating a chirped input signal;
a pump signal source configured for providing pump optical signal having a predetermined wavelength and amplitude profile; and
a cross-correlation module configured interacting said chirped input signal with said pump optical signal to thereby generate an encrypted output optical signal.

16. The encryption system of claim 15, wherein said input optical signal comprises one or more series of optical pulses, said encrypted output signals is substantially continuous optical signal.

17. The encryption system of claim 15, wherein said encryption unit is configured as all optical encryption of input optical signals.

18. The encryption system of claim 15, wherein said pump signal source further comprises a pump modulation unit configured and operable for selectively modulating spectrum or amplitude of said pump optical signal.

19. (canceled)

20. The encryption system of claim 18, wherein said pump amplitude modulation unit is configured an operable for manipulating spectrum/amplitude of said pump optical signals in accordance with data about an encryption key.

21. The encryption system of claim 15, configured as an optical fiber encryption system.

22. The encryption system of claim 15, wherein said cross-correlation module is configured to generate said encrypted output optical signal by providing nonlinear interaction between said chirped input signal and said pump optical signals, said nonlinear interaction being at least one of 4 wave-mixing 3 wave-mixing, Raman interaction, Brillouin interaction, and Kerr effect.

23. (canceled)

24. (canceled)

25. An optical decryption system, comprising:
input and output ports configured respectively for receiving an input optical signals and transmitting output optical signals;
a pump signal source configured for providing pump optical signal having a predetermined wavelength and amplitude profile;
a cross-correlation module configured interacting said input signal with said pump optical signal to thereby generate an encrypted output optical signal; and
signal dispersion unit configured for applying certain level of group velocity dispersion on said input signals.

26. The optical decryption system of claim 25, wherein said cross-correlation module comprises nonlinear birefringent element, said chirped input signal and said pump optical signal being transmitted therethrough with orthogonal polarities, to thereby provide cross-correlation between them.

27. The optical decryption system of claim 25, wherein said wavelength and amplitude profile is selected to in accordance with wavelength and amplitude profile of an encryption pump optical signal.

28. The optical decryption system of claim 25, wherein said decryption system is configured as all optical decryption of input optical signals.

29. The optical decryption system of claim 25, wherein said pump signal source further comprises a pump modulation unit configured and operable for selectively modulating spectrum or amplitude of said pump optical signal.

30. (canceled)

31. The optical decryption system of claim 29, wherein said pump amplitude modulation unit is configured an operable for manipulating spectrum/amplitude of said pump optical signals in accordance with data about an encryption key.

32. The optical decryption system of claim 25, configured as an optical fiber encryption system.

33. The optical decryption system of claim 25, wherein said cross-correlation module is configured for generation 4 wave mixing interaction between said input signal and said pump optical signals.

34. (canceled)

35. (canceled)
